(19) United States
(12) Patent Application Publication
(10) Pub. No.: US 2009/0107264 A1
(43) Pub. Date: Apr. 30, 2009

(54) Automated Battery Plate Inspection

(75) Inventor: Oliver A. Bell, Aiken, SC (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/926,899

(22) Filed: Oct. 29, 2007

(51) Int. Cl. G01M 19/00

(52) U.S. Cl. 73/865.8

(57) ABSTRACT

A quality inspection system and method for identifying faulty battery plates is provided, wherein the plates comprise lead grids that have undergone a pasting process. In various embodiments, the quality inspection system includes a first scanner positioned to sequentially scan a first surface of each of a plurality of the battery plates, after the lead grids have undergone the pasting process. The first scanner scans the first surface of each plate for anomalies and communicates scanned first surface data to a processing center. The processing center analyzes the first surface data and determines an integrity status of the first surface, i.e., whether anomalies exist in the first surface. If anomalies exist in the first surface of any plate the respective plate can be discarded.

### FIELD

The present teachings relate to quality inspection of plates used in the manufacturing lead-acid batteries.

### BACKGROUND

The statements in this section merely provide background information related to the present disclosure and may not constitute prior art.

Lead-acid batteries are used to provide an electrical power source for many different uses. For example, lead-acid batteries are prevalently used as a power source to provide power for starting, lighting, and ignition services on all types of vehicles, such as automobiles, trucks, boats, trains, aircraft, submarines, and almost all other motive vehicles. Additionally, lead-acid batteries are commonly utilized as a power source for operating electric motors of light-weight utility vehicles, such as small cargo/maintenance vehicles, shuttle vehicles or golf cars. Other vital uses of lead-acid batteries are driving some electric equipment, such as wenches or a mechanical lift, and providing stand-by emergency power storage in places such as hospitals and telephone exchanges where it is vital to have an uninterrupted power supply.

The most common type of lead-acid battery consists of a heavy duty plastic box containing lead alloy pasted grids. Typically, spaces in lead grids are ‘pasted’ with a lead oxide paste. When immersed in sulphuric acid, these pasted grids, i.e., plates, form an electric cell that produces electricity from the chemical reactions that occur. One known ‘pasting’ process consists of applying a lead oxide paste to each grid. The paste is then pushed down through the grids, typically with a roller, against a conveyor belt on which the plates are processed. The paste then spreads out underneath each plate and is allowed to ‘set up’ during a pre-drying stage.

Typically, as each plate emerges from the pasting operation, an operator visually inspects the pasted grids, i.e., plates, to monitor the quality of the plates. Defective plates, that is, plates having lumps or voids, are typically hand removed to a discard or re-work bin. However, inconsistencies and oversight can commonly occur with this visual inspection process, resulting in defective batteries.

### SUMMARY

A quality inspection system and method for identifying faulty battery plates is provided, wherein the plates comprise lead grids that have undergone a pasting process. In various embodiments, the quality inspection system includes a first scanner, e.g., a laser or video device, positioned to sequentially scan a first surface of each of a plurality of the battery plates, after the lead grids have undergone the pasting process. The first scanner scans the first surface of each plate for anomalies and communicates the scanned first surface data to a processing center. The processing center analyzes the first surface data and determines an integrity status of the first surface, i.e., whether anomalies exist in the first surface. If anomalies exist in the first surface of any plate the respective plate can be discarded.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a block diagram illustrating an automated battery plate quality inspection system (ABPQIS), in accordance with various embodiments.

FIG. 2 is a front view of an exemplary battery plate that can be inspected using the ABPQIS shown in FIG. 1.

FIG. 3 is a block diagram of the ABPQIS, shown in FIG. 1, illustrating a pair of scanning devices and an automatic discard device, in accordance with various embodiments.

FIG. 4 is a block diagram of the ABPQIS, shown in FIG. 1, illustrating an automatic discard device, in accordance with various other embodiments.

FIG. 5 is a block diagram of the ABPQIS, shown in FIG. 1, illustrating an automatic discard device, in accordance with yet other various embodiments.

FIG. 6 is a block diagram of the ABPQIS, shown in FIG. 1, illustrating an automatic discard device, in accordance with still yet other various embodiments.

FIG. 7 is a block diagram of the ABPQIS, shown in FIG. 1, illustrating a single scanner for inspecting two sides of a battery plate, in accordance with various embodiments.

### DETAILED DESCRIPTION

The following description is merely exemplary in nature and is in no way intended to limit the present teachings, application, or uses. Throughout this specification, like reference numerals will be used to refer to like elements.

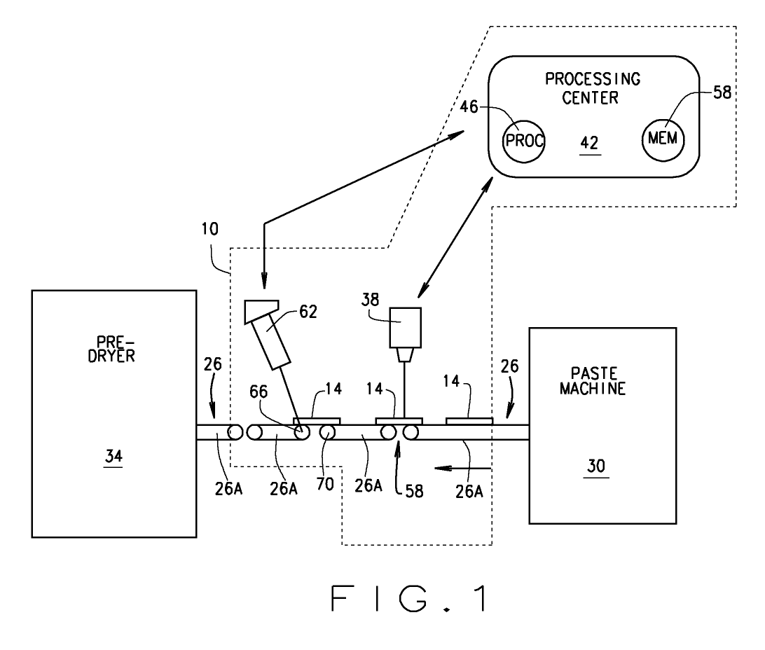

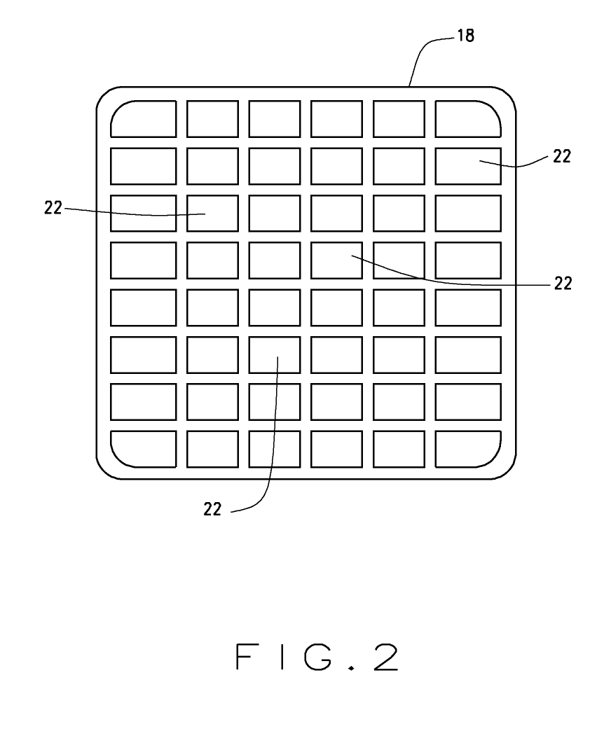

Referring to FIGS. 1 and 2, in various embodiments, an automated battery plate quality inspection system (ABPQIS) 10 is provided for identifying faulty battery plates 14. The plates 14 are generally used in lead acid batteries and include a lead grid 18 that includes a plurality of grid apertures or orifices 22. Each grid 18 has a lead alloy paste, e.g., a lead-oxide paste, applied and forced into the grid apertures 22. The paste can be applied and forced into the grid aperture 22 using any suitable application process and device. For example, in various embodiments, the grids 18 travel along a conveyor system 26 and through a paste machine 30. As the grids 18 pass through the paste machine 30, the paste machine sequentially applies the lead alloy paste to each grid 18 and forces the paste down into and through the grid apertures 22. In various exemplary embodiments, the pasted grids, i.e., the battery plates, pass along the conveyor system 26 into a pre-dryer 34 where the paste is allowed to substantially solidify, or ‘set-up’.

Referring particularly to FIG. 1, in various embodiments, the ABPQIS 10 includes the conveyor system 26, a scanner 38, and a processing center 42. The scanner 38 is communicatively connected, i.e., either wired or wirelessly connected, with the processing center 42. The processing center includes at least one processor 46, i.e., and at least one electronic memory device 50. The processor 46 can be any suitable processor for executing all functions of the ABPQIS 10. For example, in various embodiments, the processor 46 executes a plate integrity analysis algorithm stored on the memory device 50. Execution of the plate integrity analysis algorithm controls operation of the ABPQIS 10, as described herein. The memory device 50 can be any suitable computer readable medium for storing such things as data, information, software programs and algorithms that are used or executed by the processor 46 during operation of the ABPQIS 10.

The scanner 38 is positioned to sequentially scan a first surface, e.g., an upper surface, of each battery plate 14 subsequent to the lead grid 18 having the lead alloy paste applied, as described above. More particularly, the scanner 38 sequentially scans the first surface of each battery plate 14, subsequent to the pasting process, for anomalies in the first surface. As the scanner 38 scans the first surface of each battery plate 14, the scanner 38 collects first surface data, indicative of the quantity and severity of any anomalies in the first surface, and communicates the first surface data to the processing center 42. Anomalies in the first surface detected by the scanner 38 are any undesirable characteristics or features in the lead grid 18 and/or the lead alloy paste applied to the grid 18 that may cause defective or inefficient function of the plate 18 when the plate 18 is placed in a battery. For example, anomalies can include such things as cracks and/or bad grid joints in the lead grid 18, and/or voids, bumps, lumps or bubbles in the lead paste.

The scanner 38 can be any scanning device suitable for collecting the first surface data. For example, in various embodiments, the scanner 38 can be a laser scanner that emits a very narrow light beam that scans back and forth across the first surface of each battery plate 14 as the battery plates 14 travel along the conveyor system 26. Generally, the emitted beam is reflected off of the first surface back to the laser scanner 38 where the laser scanner 38 reads, or captures, the reflected signals. Bumps, bubbles, voids, cracks, etc., in the paste and/or the lead grid 18 will diffuse the light beam emitted by laser scanner 38 in different directions such that the intensity of the reflected signal is altered. The laser scanner 38 converts the reflected signals into a digital signal that includes the first surface data, indicative of the quantity and severity of any anomalies in the first surface, and transmits the signal to the processing center 42.

In various other embodiments, the scanner 38 can be an electromagnetic scanner that generates electromagnetic waves, e.g., radio frequency (RF) waves, that scan the first surface of each battery plate 14 as the battery plates 14 travel along the conveyor system 26. Generally, the generated electromagnetic waves are reflected off of the first surface back to the electromagnetic scanner 38 where the electromagnetic scanner 38 reads, or captures, the reflected electromagnetic waves. Bumps, bubbles, voids, cracks, etc., in the paste and/or the lead grid 18 will alter the reflected electromagnetic waves. The electromagnetic scanner 38 converts the reflected electromagnetic waves into a digital signal that includes the first surface data, indicative of the quantity and severity of any anomalies in the first surface, and transmits the signal to the processing center 42.

In yet other various implementations, the scanner 38 can be an ultra-sonic scanner that generates sound waves that scan the first surface of each battery plate 14 as the battery plates 14 travel along the conveyor system 26. Generally, the generated sound waves are reflected off of the first surface back to the ultra-sonic scanner 38 where the ultra-sonic scanner 38 reads, or captures, the reflected sound waves. Bumps, bubbles, voids, cracks, etc., in the paste and/or the lead grid 18 will alter the reflected sound waves. The ultra-sonic scanner 38 converts the reflected sound waves into a digital signal that includes the first surface data, indicative of the quantity and severity of any anomalies in the first surface, and transmits the signal to the processing center 42.

In still yet other various embodiments, the scanner 38 can be a magnetic scanner that generates a magnetic field that scans the first surface of each battery plate 14 as the battery plates 14 travel along the conveyor system 26. Generally, the battery plates 14 pass through the magnetic field causing interpretable disturbances in the magnetic field. Particularly, bumps, bubbles, voids, cracks, etc., in the paste and/or the lead grid 18 will create alterations or disturbances in the magnetic field that are detected or captured, and interpreted by the magnetic scanner 38. The magnetic scanner 38 converts the captured disturbances into a digital signal that includes the first surface data, indicative of the quantity and severity of any anomalies in the first surface, and transmits the signal to the processing center 42.

In still further various embodiments, the scanner 38 can be a video device that generates images of the first surface of each battery plate 14 as the battery plates 14 travel along the conveyor system 26. Generally, the battery plates 14 pass through a viewing field of the video device 38 where images of the battery plates 14 and any bumps, bubbles, voids, cracks, etc., in the paste and/or the lead grid 18 are captured. The video device 38 converts the captured images into a digital signal that includes the first surface data, indicative of the quantity and severity of any anomalies in the first surface, and transmits the signal to the processing center 42.

Once the processing center 42 receives the first surface data, the processing center 42 analyzes the first surface data to determine the integrity of the scanned first surface. Particularly, the processor 46 executes the plate integrity analysis algorithm to collect the first surface data and analyze the first surface data to determine the integrity of the first surface of each battery plate 14 as each battery plate 14 travels long the conveyor system 26. If the integrity of the first surface of a battery plate 14 is determined to be flawed or undesirable, the processing center 42, i.e., execution of the plate integrity analysis algorithm, identifies, or ‘flags’, the particular battery plate 14 as defective. The processing center 42 can flag the defective battery plate 14 as defective using any desirable method, device, alarm, light, signal or other suitable indicator. For example, when a particular battery plate 14 is flagged as defective, the processing center 46 can sound an alarm or illuminate a light emitting diode (LED) to inform and instruct an operator to remove the defective battery plate 14 from the conveyor system 26.

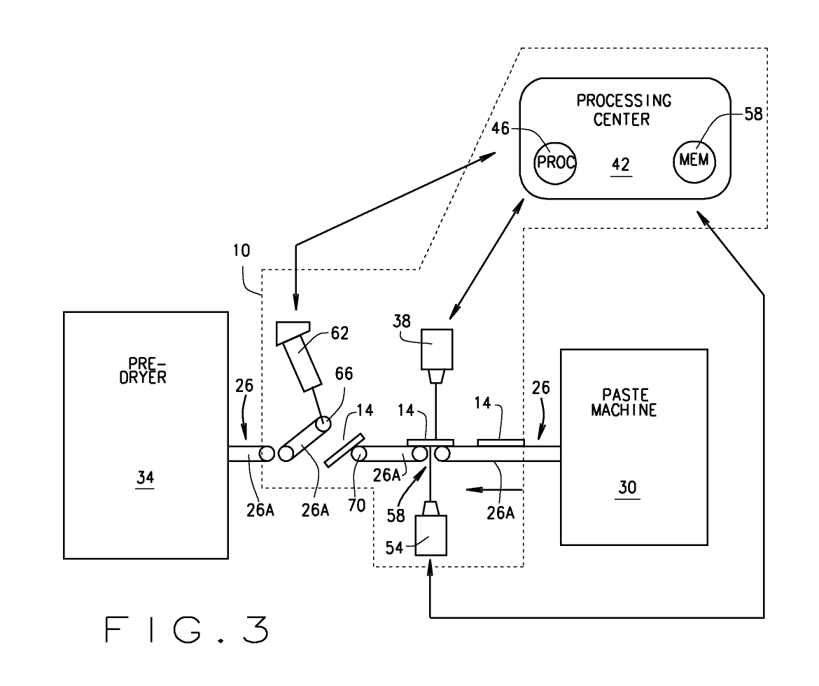

Referring now to FIG. 3, in various embodiments, the ABPQIS 10 additionally includes a second scanner 55 also communicatively connected, i.e., either wired or wirelessly connected, with the processing center 42. The second scanner 54 is positioned to sequentially scan a second surface, e.g., a lower surface, of each battery plate 14 subsequent to the lead grid 18 having the lead alloy paste applied, as described above. More particularly, the second scanner 54 sequentially scans the second surface of each battery plate 14, subsequent to the pasting process, for anomalies in the second surface. As the second scanner 54 scans the second surface of each battery plate 14, the second scanner 54 collects second surface data, indicative of the quantity and severity of any anomalies in the second surface, and communicates the second surface data to the processing center 42.

As described above, with respect to the first surface, anomalies are any undesirable characteristic or feature in the lead grid 18 and/or the lead alloy paste applied to the grid 18 that may cause defective or inefficient function of the plate 18 when the plate 18 is placed in a battery. For example, anomalies can include such things as cracks and/or bad grid joints in the lead grid 18, and/or voids, bumps, lumps or bubbles in the lead paste. To allow scanning of the second side, in various embodiments, the conveyer system includes a plurality of sections 26A having a gap 58, i.e., a space, slot or opening, between two adjacent conveyor sections 26A. More specifically, as the battery plates 14 travel along the conveyor system 26 subsequent to the pasting process, each battery plate 14 passes over the gap 58 as the battery plate 14 transitions from one section 26A to a subsequent section 26A. As each battery plate passes over the gap 58, a width-wide portion of the second surface is exposed from, or unencumbered by, the conveyor sections 26A such that the second scanner 54 can scan the second surface.

Similar to the scanner 38, also sometimes referred to herein as the first scanner 38, the second scanner 54 can be any scanning device suitable for collecting the second surface data. For example, in various embodiments, the second scanner 54 can be a laser scanner that emits a very narrow light beam projected through the gap 58. The light beam scans back and forth across the second surface of each battery plate 14 as the battery plates 14 travel over the gap 58 and along the conveyor system 26. The emitted beam is reflected off of the second surface back to the laser second scanner 54 where the laser second scanner 54 reads, or captures, the reflected signals. Bumps, bubbles, voids, cracks, etc., in the paste and/or the lead grid 18 will diffuse the light beam emitted by the laser second scanner 54 in different directions such that the intensity of the reflected signal is altered. The laser second scanner 54 converts the reflected signals into a digital signal that includes the second surface data, indicative of the quantity and severity of any anomalies in the second surface, and transmits the signal to the processing center 42.

In various other embodiments, the second scanner 54 can be an electromagnetic scanner that generates electromagnetic waves, e.g., radio frequency (RF) waves, that scan the second surface of each battery plate 14 as the battery plates 14 travel over the gap 58 and along the conveyor system 26. Generally, the generated electromagnetic waves are reflected off of the second surface and back to the electromagnetic second scanner 54 where the electromagnetic second scanner 54 reads, or captures, the reflected electromagnetic waves. Bumps, bubbles, voids, cracks, etc., in the paste and/or the lead grid 18 will alter the reflected electromagnetic waves. The electromagnetic second scanner 54 converts the reflected electromagnetic waves into a digital signal that includes the second surface data, indicative of the quantity and severity of any anomalies in the second surface, and transmits the signal to the processing center 42.

In yet other various implementations, the second scanner 54 is an ultra-sonic scanner that generates sound waves that scan the second surface of each battery plate 14 as the battery plates 14 travel across the gap 58 and along the conveyor system 26. Generally, the generated sound waves are reflected off of the second surface and back to the ultra-sonic second scanner 54 where the ultra-sonic second scanner 54 reads, or captures, the reflected sound waves. Bumps, bubbles, voids, cracks, etc., in the paste and/or the lead grid 18 will alter the reflected sounds waves. The ultra-sonic second scanner 54 converts the reflected sound waves into a digital signal that includes the second surface data, indicative of the quantity and severity of any anomalies in the second surface, and transmits the signal to the processing center 42.

In still yet other various embodiments, the second scanner 54 is a magnetic scanner that generates a magnetic field that scans the second surface of each battery plate 14 as the battery plates 14 travel across the gap 58 and along the conveyor system 26. Generally, the battery plates 14 pass through the magnetic field causing interpretable disturbances in the magnetic field. Particularly, bumps, bubbles, voids, cracks, etc., in the paste and/or the lead grid 18 will create alterations or disturbances in the magnetic field that are detected or captured, and interpreted by the magnetic second scanner 54. The magnetic second scanner 54 converts the captured disturbances into a digital signal that includes the second surface data, indicative of the quantity and severity of any anomalies in the second surface, and transmits the signal to the processing center 42.

In still further various embodiments, the second scanner 54 can be a video device that generates images of the second surface of each battery plate 14 as the battery plates 14 travel across the gap 58 and along conveyor system 26. Generally, as the battery plates 14 pass across the gap 58 the video device 54 captures images of the battery plates 14 and any bumps, bubbles, voids, cracks, etc., in the paste and/or the lead grid 18. The video device 54 converts the captured images into a digital signal that includes the second surface data, indicative of the quantity and severity of any anomalies in the second surface, and transmits the signal to the processing center 42.

Therefore, as illustrated in FIG. 3, the processing center receives first surface data from first scanner 38 and/or second surface data from the second scanner 54. Once the processing center 42 receives the first and/or second surface data, the processing center 42 analyzes the first and/or second surface data to determine the integrity of the first and/or second surface. Particularly, the processor 46 executes the plate integrity analysis algorithm to collect the first and/or second surface data and analyze the first and/or second surface data to determine the integrity of the first and/or second surface of each battery plate 14 as each battery plate 14 travels long the conveyor system 26. If the integrity of the first and/or second surface of a battery plate 14 is determined to be flawed or undesirable, the processing center 42, i.e., execution of the plate integrity analysis algorithm, identifies, or ‘flags’, the particular battery plate 14 as defective, as describe above.

Still referring to FIG. 3, in various embodiments, the ABPQIS 10 further includes an automatic discard device 62 that is communicatively connected, i.e., wired or wirelessly connected, to the processing center 42. If the integrity of the first and/or second surface of a battery plate 14 is determined to be flawed or undesirable, the processing center 42, i.e., execution of the plate integrity analysis algorithm, activates the automatic discard device 62. Activation of the discard device 62 automatically removes the defective battery plate 14 from the conveyor system 26. That is, the discard device 62 automatically discards all battery plates 14 that are flagged as defective. The discard device 62 can be any device or mechanism suitable to automatically remove battery plates 14 flagged as defective from the conveyor system 26.

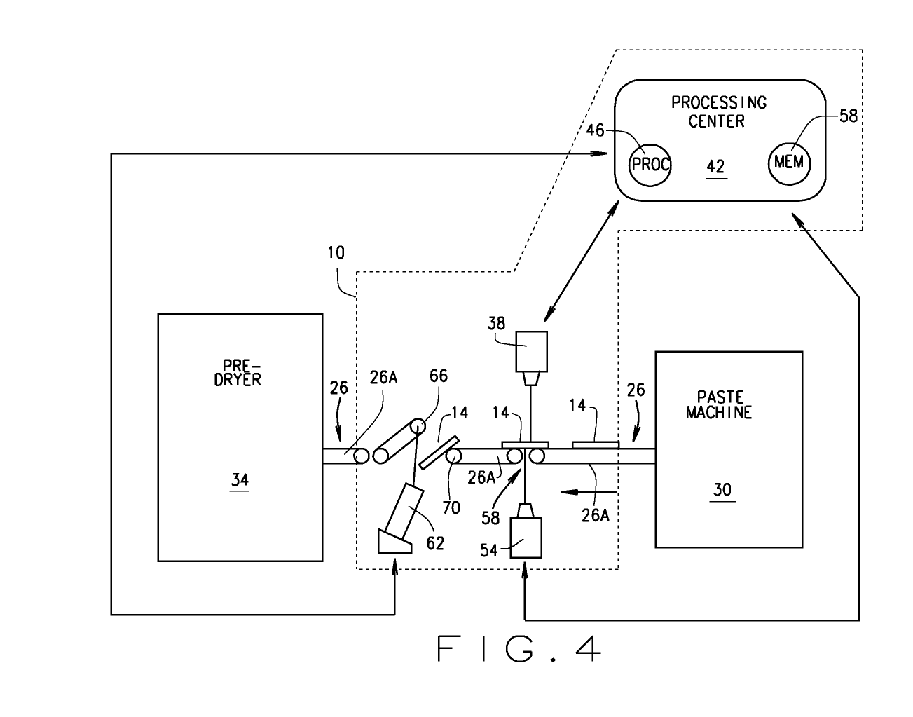

For example, in various embodiments, the discard device comprises as lift device that rotationally lifts a conveyor section 26 such that the defective battery plate 14 falls off the conveyor system 26. More particularly, the lift device raises a leading end 66 of a conveyor section 26A such that the defective batter plate 14 falls off a trailing end 70 of the adjacent conveyor section 26A as the defective battery plate 14 travels along the conveyor system 26. The lift device can be any device suitable for raising the leading end of the conveyor section 26A to allow the defective battery plate to fall off the trailing edge 70 of the adjacent conveyor section 26A. For example, the lift device, i.e., the discard device 62, can be a retraction device positioned above the conveyor system 26 to pull up on the leading end 66, as illustrated in FIGS. 1 and 3. Pulling up on the leading end 66 raises the conveyor section 26A and allows the defective battery plate 14 to fall off the trailing end 70 of the adjacent conveyor section 26A. Or, the lift device, i.e., the discard device 62, can be an extension device positioned below the conveyor system 26 to push up on the leading end 66, as illustrated in FIG. 4. Pushing up on the leading end 66, likewise, raises the conveyor section 26A and allows the defective battery plate 14 to fall off the trailing end 70 of the adjacent conveyor section 26A. A discard bin (not shown) can be positioned beneath the conveyor system 26 such that as the defective battery plates 14 fall off the trailing end 70 of the conveyor section 26A, the defective battery plates 14 fall into the discard bin.

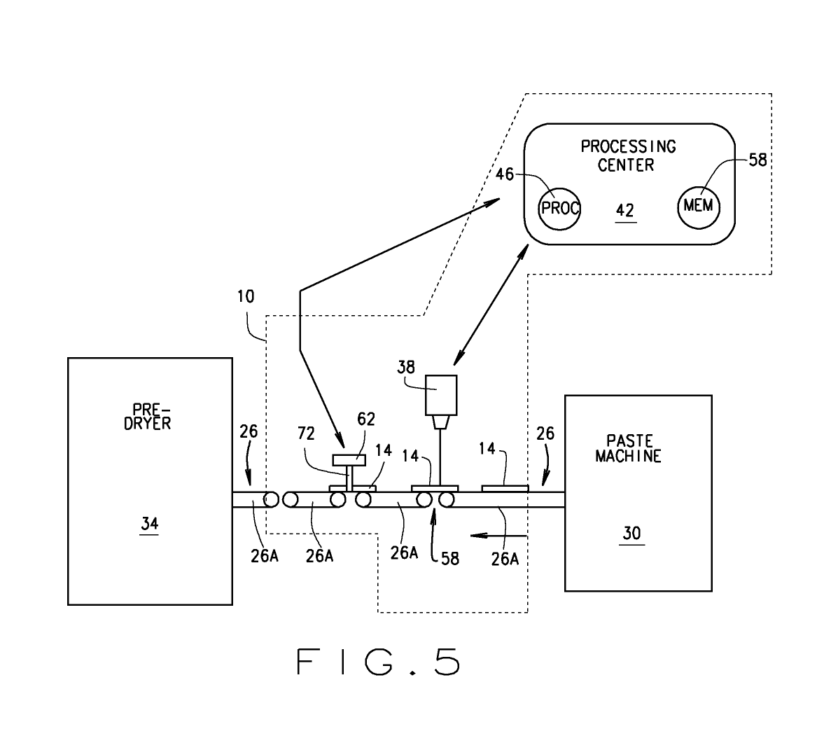

In various other embodiments, the discard device 62 can be a sweep-arm device configured sweep or push the defective battery plate off the conveyor system 26, as illustrated in FIG. 5. If the integrity of the first and/or second surface of a battery plate 14 is determined to be flawed or undesirable, the processing center 42 activates the sweep-arm discard device 62. Activation of the sweep-arm discard device 62 pivotally rotates a sweep-arm 72 that contacts the defective battery plate 14 to automatically push the defective battery plate 14 off the conveyor system 26. That is, the sweep-arm discard device 62 automatically discards all battery plates 14 that are flagged as defective by physically sweeping, pushing or knocking the defective battery plates 14 off the conveyor system 26. A discard bin (not shown) can be positioned beneath the conveyor system 26 such that as the defective battery plates 14 are swept off of the conveyor section 26A, the defective battery plates 14 fall into the discard bin.

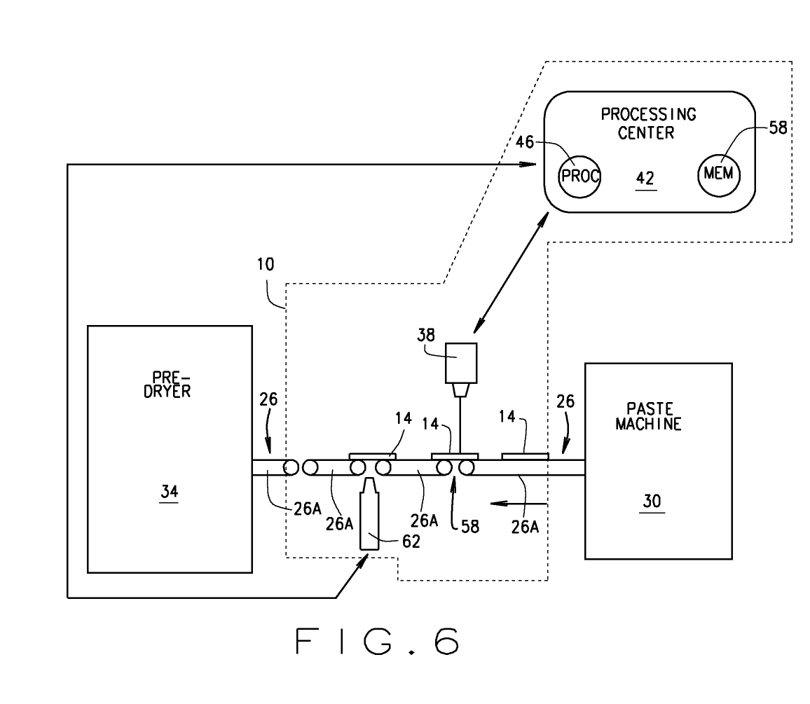

In still other various embodiments, the discard device 62 can be a forced air device configured to discharge a pulse or puff of air, or other suitable gaseous substance, as illustrated in FIG. 6. The forced air device is positioned below the conveyor system 26 and oriented to discharge the puff of air through a gap 74, i.e., a space or opening, between two adjacent conveyor sections 26A. If the integrity of the first and/or second surface of a battery plate 14 is determined to be flawed or undesirable, the processing center 42 activates the forced air discard device 62. Activation of the forced air discard device 62 causes the forced air discard device to discharge the puff of air directed at the defective battery plate 14, e.g., an edge portion of the defective battery plate 14, as the defective battery plate 14 passes over the gap 74. The forced air discard device is calibrated to discharge the puff air with sufficient force to effectively flip or knock the defective battery plate 14 off of the conveyor system 26. That is, the forced air discard device 62 automatically discards all defective battery plates 14 by effective blowing them off the conveyor system 26 using a puff of forced or air. A discard bin (not shown) can be positioned beneath the conveyor system 26 such that as the defective battery plates 14 are blown off of the conveyor section 26A, the defective battery plates 14 fall into the discard bin.

Referring again to FIGS. 1, 5 and 6, although the scanner 38 is illustrated as being positioned above the conveyor system 26 such that the first surface is effectively the top surface of each battery plate 14, it should be understood that in various embodiments, the scanner 38 is positioned below the conveyor system 26. In such instances, the conveyor system 26 includes the conveyor sections 26A and the gap 58, as described above with reference to FIG. 3. Accordingly, the first surface would effectively be the bottom surface, which would be scanned, as described above, by the scanner 38 positioned below the conveyor system 26.

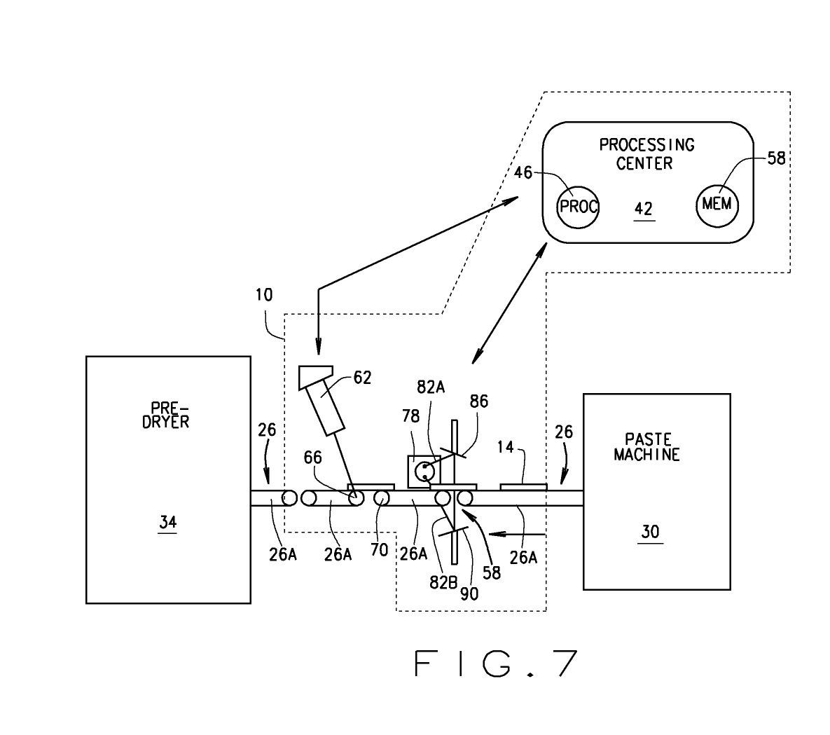

Referring now to FIG. 7, in various embodiments, the ABPQIS 10 can include a single scanner 78 configured to substantially simultaneously scan the first and the second surfaces. In various implementations, the scanner 78 can be a laser scanner that utilizes a beam splitter (not shown) to split a very narrow beam of light emitted from the laser scanner 78. The beam splitter can be either internal to the scanner 78 or external to the scanner 78. The beam splitter splits the light beam emitted by the laser scanner 78 into a first portion 82A and a second portion 82B. The first light portion 82A is reflected off of a first reflector 86, e.g., mirror, such that a very narrow light beam scans back and forth across the first surface of each battery plate 14 as the battery plates 14 travel along the conveyor system 26. Generally, the first portion 82A of the emitted beam is reflected off of the first surface back to the first reflector 86 and then to the laser scanner 78 where the laser scanner 78 reads, or captures, the reflected signals.

Similarly, the second light portion 82B is reflected off of a second reflector 90, e.g., mirror, such that a very narrow light beam scans back and forth across the second surface of each battery plate 14 as the battery plates 14 travel along the conveyor system 26. Generally, the second portion 82B of the emitted beam is reflected off of the second surface back to the second reflector 90 and then to the laser scanner 78 where the laser scanner 78 reads, or captures, the reflected signals. Bumps, bubbles, voids, cracks, etc., in the paste and/or the lead grid 18 of the first and second surfaces will diffuse the first and/or second portions 82A and/or 82B of the light beam emitted by laser scanner 78 in different directions such that the intensity of the reflected signals are altered. The laser scanner 78 converts the reflected signals into one or more digital signals that include the first surface and second surface data, indicative of the quantity and severity of any anomalies in the first and/or second surface, and transmits the signal(s) to the processing center 42.

Alternatively, fiber optic cables can be utilized to transmit the signal portions 82A and 82B to the first and second surfaces and receive the respective reflected signals from the first and second surfaces. Accordingly, in such embodiments, the first and second reflectors 86 and 90 would be unnecessary. As described above, the laser scanner 78 would then convert the reflected signals into one or more digital signals that include the first surface and second surface data, indicative of the quantity and severity of any anomalies in the first and/or second surface, and transmit the signal(s) to the processing center 42.

With further reference to FIG. 7, in other various implementations, the scanner 78 can be a video device that utilizes a light splitter (not shown), e.g., one or more lenses or mirrors, to split an optical field of view of the video device 78. The light splitter can be either internal to the scanner 78 or external to the scanner 78. The light splitter splits the optical field of the video scanner 78 into a first portion 82A and a second portion 82B. The first light portion 82A is reflected off of a first reflector 86, e.g., mirror, such that the video device 78 generates images of the first surface of each battery plate 14 as the battery plates 14 travel along the conveyor system 26. Generally, the battery plates 14 pass through a first viewing field of the video device 78 where images of the battery plates 14 and any bumps, bubbles, voids, cracks, etc., in the paste and/or the lead grid 18 are captured. The video device 78 converts the captured images into a digital signal that includes the first surface data, indicative of the quantity and severity of any anomalies in the first surface, and transmits the signal to the processing center 42.

Similarly, the second light portion 82B is reflected off of a second reflector 90, e.g., mirror, such that the video device 78 generates images of the second surface of each battery plate 14 as the battery plates 14 travel along the conveyor system 26. Generally, the battery plates 14 pass through a second viewing field of the video device 78 where images of the battery plates 14 and any bumps, bubbles, voids, cracks, etc., in the paste and/or the lead grid 18 are captured. The video device 78 converts the captured images into a digital signal that includes the second surface data, indicative of the quantity and severity of any anomalies in the second surface, and transmits the signal to the processing center 42.

Therefore, as described above, the processing center 42 receives first surface data and/or second surface data from the single scanner 78. Once the processing center 42 receives the first and/or second surface data, the processing center 42 analyzes the first and/or second surface data to determine the integrity of the first and/or second surface as described above.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A quality inspection system for a battery plate pasting system, said quality inspection system comprising a first scanner positioned to scan a first surface of a battery plate for anomalies and communicate scanned first surface data to a processing center to determine a first surface integrity of the scanned plate.

2. The system of claim 1, wherein the system further comprises a second scanner positioned to scan a second surface of a battery plate for anomalies and communicate scanned second surface data to the processing center to determine a second surface integrity of the scanned plate.

3. The system of claim 2, wherein the system further comprises a discard device communicatively connected to the processing center for automatically discarding the plate if the integrity of at least one of the first surface and the second surface is determined to be flawed.

4. The system of claim 2, wherein at least one of the first and second scanners comprises a laser scanner.

5. The system of claim 2, wherein at least one of the first and second scanners comprises one of an electromagnetic wave scanner, a sound wave scanner and a magnetic field scanner.

6. The system of claim 1, wherein the system further comprises a discard device communicatively connected to the processing center for automatically discarding the plate if the integrity of the first surface is determined to be flawed.

7. The system of claim 1, wherein the first scanner comprises a laser scanner.

8. The system of claim 1, wherein the first scanner comprises one of an electromagnetic wave scanner, a magnetic field scanner and a sound wave scanner.

9. A method for inspecting battery plates, said method comprising:
sequentially scanning a first surface of each of a plurality of battery plates for anomalies;
communicating scanned first surface data to a processing center; and
analyzing the first surface data to determine an quality status of the first surface.

10. The method of claim 9, wherein sequentially scanning comprises optically scanning the first surface using a laser scanner.

11. The method of claim 9, wherein sequentially scanning comprises one of:
scanning the first surface using electromagnetic waves;
scanning the first surface using a magnetic field and
scanning the first surface using sound waves.

12. The method of claim 9, wherein analyzing the first surface data comprises executing a surface anomaly algorithm to operate on the first surface data received at the processing center to determine the integrity of the first surface.

13. The method of claim 9, wherein analyzing the first surface data comprises comparing the first surface data received at the processing center to stored control data to determine the integrity of the first surface.

14. The method of claim 9, wherein the method further comprises automatically discarding the plate if the integrity of the first surface is determined to be flawed.

15. The method of claim 9, wherein the method further comprises
sequentially scanning a second surface of each of the battery plates for anomalies;
communicating scanned second surface data to the processing center; and
analyzing the second surface data to determine an quality status of the second surface.

16. The method of claim 15, wherein the method further comprises automatically discarding the plate if the integrity at least one of the first surface and the second surface is determined to be flawed.

17. A battery plate pasting system, said system comprising:
a pasting machine adapted to sequentially apply a paste to each of a plurality of battery plate grids as the grids pass through the pasting machine along a conveyor system;
a first scanner positioned to sequentially scan a first surface of each pasted grid for anomalies as the pasted grids travel along the conveyor system after exiting the pasting machine;
a processing center communicatively connected to the first scanner to receive first surface data and determine an integrity of the scanned first surface of the pasted grid.

18. The system of claim 17, wherein the first scanner comprises one of:
a laser scanner;
an electromagnetic scanner;
a magnetic scanner;
a ultra-sonic scanner; and
a video device.

19. The system of claim 17, wherein the system further comprises a discard device communicatively connected to the processing center for automatically discarding any pasted grid if the integrity of the first surface of the respective pasted grid is determined to be flawed.

20. The system of claim 19, wherein the system further comprises a second scanner positioned to sequentially scan a second surface of each pasted grid for anomalies as the pasted grids travel along the conveyor system after exiting the pasting machine, the second scanner communicatively connected to the processing center to transmit second surface data the processing center to determine an integrity of the scanned second surface of the pasted grid.

21. The system of claim 20, wherein the system further comprises a discard device communicatively connected to the processing center for automatically discarding the plate if the integrity of at least one of the first surface and the second surface is determined to be flawed.

22. A quality inspection system for a battery plate pasting system, said quality inspection system comprising a single scanner positioned to substantially simultaneously scan a first surface and a second surface of a battery plate for anomalies and communicate scanned first surface data and scanned second surface data to a processing center to determine a first surface integrity and a second surface integrity of the scanned plate.
